(19) United States
(12) Patent Application Publication
(10) Pub. No.: US 2025/0304501 A1
(43) Pub. Date: Oct. 2, 2025

(54) DIELECTRIC CERAMIC COMPOSITION AND MULTILAYER CERAMIC ELECTRONIC DEVICE

(71) Applicant: TDK Corporation, Tokyo (JP)

(72) Inventors: Taku MURAKAMI, Tokyo (JP); Nobuto Morigasaki, Tokyo (JP); Yutaka Suwazono, Tokyo (JP); Toshihiro Iguchi, Tokyo (JP); Ayako Sato, Tokyo (JP); Yasuhiro Ito, Tokyo (JP)

(73) Assignee: TDK Corporation, Tokyo (JP)

(21) Appl. No.: 19/083,688

(22) Filed: Mar. 19, 2025

(30) Foreign Application Priority Data
Mar. 27, 2024 (JP) 2024-052273

(51) Int. Cl. C04B 35/465; H01G 4/12

(52) U.S. Cl. CPC C04B 35/465; H01G 4/1281; C04B 2235/3232; C04B 2235/768; C04B 2235/785; C04B 2235/786; C04B 2235/96

(57) ABSTRACT

A dielectric ceramic composition includes main phase grains and a grain boundary between the main phase grains. The main phase grains include a perovskite compound as a main component. The perovskite compound includes at least Ca and Sr as A-site elements and at least Zr and Ti as B-site elements. The dielectric ceramic composition further includes an oxide of at least one additional element. β/α is 3.0 or more and 6.0 or less, where α (unit: parts by mol) denotes a content of the at least one additional element of the dielectric ceramic composition with respect to 100 parts by mol B-site elements, and β (unit: parts by mol) denotes a content of the at least one additional element of the grain boundary with respect to 100 parts by mol B-site elements.

### TECHNICAL FIELD

The present invention relates to a dielectric ceramic composition and a multilayer ceramic electronic device.

### BACKGROUND

Patent Document 1 discloses an invention related to a nonreducible dielectric ceramic composition and a multilayer ceramic capacitor including ceramic sheets composed of the nonreducible dielectric ceramic composition and electrodes alternately laminated.
Patent Document 1: JP Patent Application Laid Open No. 2007-91588

### SUMMARY

The present invention is directed to a dielectric ceramic composition that enables a multilayer ceramic electronic device with good temperature characteristics and high reliability to be provided.

In response to the above, a dielectric ceramic composition according to the present invention is
a dielectric ceramic composition including:
main phase grains; and
a grain boundary between the main phase grains,
wherein
the main phase grains include a perovskite compound as a main component;
the perovskite compound includes at least Ca and Sr as A-site elements and at least Zr and Ti as B-site elements;
the dielectric ceramic composition further includes an oxide of at least one additional element; and
β/α is 3.0 or more and 6.0 or less, where
α (unit: parts by mol) denotes a content of the at least one additional element of the dielectric ceramic composition with respect to 100 parts by mol B-site elements, and
β (unit: parts by mol) denotes a content of the at least one additional element of the grain boundary with respect to 100 parts by mol B-site elements.

Ti may constitute 2.0 parts by mol or more and 6.0 parts by mol or less out of 100 parts by mol B-site elements;
the at least one additional element may include at least Si and Al;
the dielectric ceramic composition may have a Ti content exceeding a total content of Si and Al of the dielectric ceramic composition; and
the grain boundary may have a total content of Si and Al exceeding a Ti content of the grain boundary.

Ti may constitute 2.0 parts by mol or more and 6.0 parts by mol or less out of 100 parts by mol B-site elements;
the at least one additional element may include at least one selected from the group consisting of Mn and Cr;
the dielectric ceramic composition may have a Ti content exceeding a total content of Mn and Cr of the dielectric ceramic composition; and
the grain boundary may have a total content of Mn and Cr exceeding a Ti content of the grain boundary.

The at least one additional element may include Si, Al, and at least one selected from the group consisting of Mn and Cr;
the dielectric ceramic composition may have a total content of the at least one additional element of 1.8 parts by mol or more and 5.0 parts by mol or less with respect to 100 parts by mol B-site elements;
the dielectric ceramic composition may have a total content of Mn and Cr exceeding a Si content of the dielectric ceramic composition; and
the grain boundary may have a Si content exceeding a total content of Mn and Cr of the grain boundary.

The main phase grains may have an average grain size of 0.50 um or more and 1.20 um or less.

A multilayer ceramic electronic device according to the present invention includes the dielectric ceramic composition described above.

### BRIEF DESCRIPTION OF THE DRAWING(S)

FIG. 1 is a schematic sectional view of a multilayer ceramic capacitor according to one embodiment of the present invention.

FIG. 2 is a HAADF image of a dielectric ceramic composition according to the one embodiment of the present invention.

FIG. 3 is a graph showing results of a line analysis.

FIG. 4 is a graph showing results of the line analysis.

FIG. 5 is a graph showing results of the line analysis.

### DETAILED DESCRIPTION

Hereinafter, the present invention is described with reference to a specific embodiment.

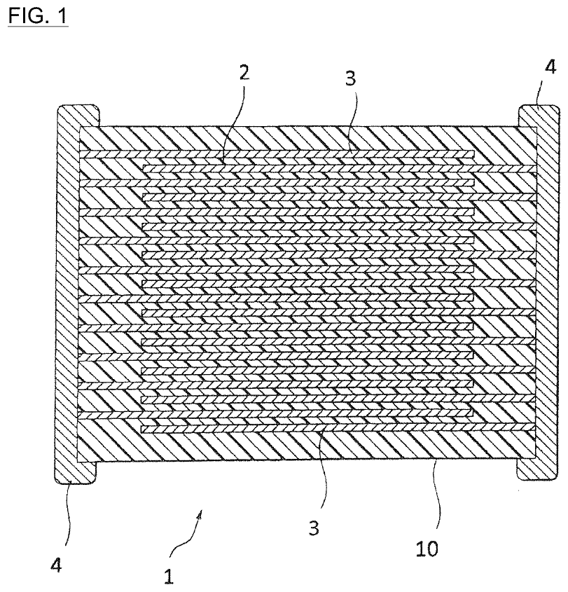

FIG. 1 shows a multilayer ceramic capacitor 1 as an example multilayer ceramic electronic device according to the present embodiment. The multilayer ceramic capacitor 1 includes an element body 10, in which dielectric layers 2 and internal electrode layers 3 are alternately laminated. At both ends of the element body 10, a pair of external electrodes 4 is provided. The external electrodes 4 are electrically connected to the internal electrode layers 3 alternately arranged inside the element body 10. The element body 10 may have any shape but normally has a rectangular parallelepiped shape. The element body 10 may have any dimensions. The dimensions are appropriately determined according to uses.

The dielectric layers 2 are composed of a dielectric ceramic composition according to the present embodiment described later. The dielectric layers 2 may have any thickness (interlayer thickness) per layer. The interlayer thickness can be freely determined according to desired characteristics, uses, etc. Normally, the interlayer thickness is preferably 100 um or less or is more preferably 30 um or less. The number of the dielectric layers 2 is not limited. In the present embodiment, the number of the dielectric layers 2 is preferably, for example, twenty or more.

The internal electrode layers 3 are laminated so that their end surfaces are alternately exposed to surfaces of two ends of the element body 10 facing each other.

The internal electrode layers 3 contain a conductive material having a main component composed of metal. The metal is not limited and is, for example, a conductive material known as metal (e.g., Pd, a Pd based alloy, Pt, a Pt based alloy, Ni, a Ni based alloy, Cu, and a Cu based alloy). The metal may contain about 0.1 mass % or less each of various trace components, such as P, S, and Cl. To form the internal electrode layers 3, a commercially available electrode paste may be used. The thickness of the internal electrode layers 3 is appropriately determined according to uses or the like.

The external electrodes 4 may contain any conductive material. For example, a known conductive material (e.g., Ni, Cu, Sn, Ag, Pd, Pt, Au, their alloys, and a conductive resin) is used. The thickness of the external electrodes 4 is appropriately determined according to uses or the like.

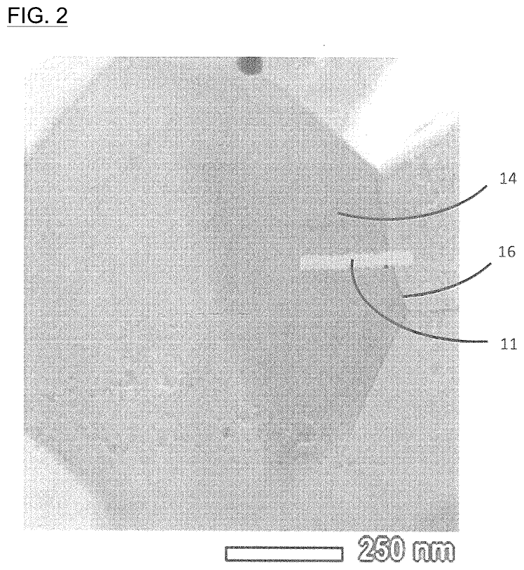

Any method of observing the structure of the dielectric ceramic composition may be used. For example, a backscattered electron image or a HAADF image of a section of the dielectric ceramic composition is observed. The backscattered electron image can be obtained using, for example, a scanning electron microscope (SEM). The HAADF image can be obtained using, for example, a scanning transmission electron microscope (STEM). FIG. 2 is a HAADF image of a section of the dielectric ceramic composition. Note that FIG. 2 is a HAADF image of Example 1 described later. Note that, in the following description, a HAADF image observed using a STEM may simply be referred to as a STEM image.

As shown in FIG. 2, the dielectric ceramic composition according to the present embodiment includes main phase grains 14 and a grain boundary 16 between the main phase grains 14. The main phase grains 14 are often identifiable as light-contrast portions compared to the grain boundary 16 in a backscattered electron image. This is because the main phase grains 14 are often denser than the grain boundary 16. Thus, the grain boundary 16, which is often less dense than the main phase grains 14, is often identifiable as a dark-contrast portion.

A field of view for shooting may have any size. The field of view has, for example, a dimension of about 1 to 50 um on all four sides and an area of about 1 to 2500 um². The size of the field of view for shooting is appropriately selected according to purpose.

The main phase grains 14 contain a perovskite compound as a main component. A perovskite compound is a compound having a perovskite-type crystal structure represented by a formula ABO₃ (where A includes A-site elements and B includes B-site elements).

The perovskite compound contains at least Ca and Sr as A-site elements and at least Zr and Ti as B-site elements. The perovskite compound may further contain Ba as an A-site element and Hf as a B-site element.

In a situation where only Sr is contained and Ca is not contained as an A-site element, temperature characteristics and reliability are reduced. In a situation where only Ca is contained and Sr is not contained as an A-site element, insulation characteristics are reduced. In a situation where neither Ca nor Sr is contained as an A-site element, temperature characteristics are reduced, and reliability is significantly reduced.

In a situation where only Zr is contained and Ti is not contained as a B-site element, temperature characteristics are reduced. In a situation where only Ti is contained and Zr is not contained as a B-site element, temperature characteristics are significantly reduced. In a situation where neither Zr nor Ti is contained as a B-site element, temperature characteristics and reliability are reduced.

Out of 100 parts by mol A-site elements, the Ca content may be 30 parts by mol or more and 90 parts by mol or less or may be 50 parts by mol or more and 80 parts by mol or less. Out of 100 parts by mol A-site elements, the Sr content may be 10 parts by mol or more and 50 parts by mol or less or may be 20 parts by mol or more and 45 parts by mol or less. Out of 100 parts by mol A-site elements, the Ba content may be 0 parts by mol or more and 20 parts by mol or less or may be 0 parts by mol or more and 5.0 parts by mol or less.

Out of 100 parts by mol B-site elements, the Zr content may be 90 parts by mol or more and 99 parts by mol or less or may be 94 parts by mol or more and 98 parts by mol or less. Out of 100 parts by mol B-site elements, the Ti content may be 0.5 parts by mol or more and 8.0 parts by mol or less or may be 2.0 parts by mol or more and 6.0 parts by mol or less. Out of 100 parts by mol B-site elements, the Hf content may be 0 parts by mol or more and 2.0 parts by mol or less. In particular, a Ti content of 2.0 parts by mol or more out of 100 parts by mol B-site elements readily and sufficiently improves sinterability. In particular, a Ti content of 6.0 parts by mol or less out of 100 parts by mol B-site elements limits the content of Ti, whose valence readily changes, to readily improve reliability and, moreover, temperature characteristics.

The dielectric ceramic composition according to the present embodiment further contains, other than the above perovskite compound, an oxide of an additional element or oxides of additional elements. The additional element or elements may be of any kind. However, the additional elements do not include oxygen. The additional elements also do not include elements that do not bond with oxygen to form oxides.

As the additional elements, at least one selected from Mn and Cr may be contained. Containing at least one selected from Mn and Cr readily improves sinterability and readily enables β/α to be within a range described later, particularly 6.0 or less.

As the additional elements, Si and Al may be contained; or Si, Al, and at least one selected from Mn and Cr may be contained. As the additional elements, elements other than Mn, Cr, Si, and Al (e.g., Mg, Li, B, and/or V) may be contained.

β/α is 3.0 or more and 6.0 or less, where α (unit: parts by mol) denotes the total content of the additional elements of the dielectric ceramic composition with respect to 100 parts by mol B-site elements and β (unit: parts by mol) denotes the total content of the additional elements of the grain boundary 16 with respect to 100 parts by mol B-site elements.

In a situation where β/α is 3.0 or more and 6.0 or less, relatively much oxides of the additional elements are contained in the grain boundary 16. It is assumed that, because a movement of oxygen vacancy is readily prevented or mitigated in this situation, high reliability can be achieved while good temperature characteristics are maintained. In a situation where β/α is too low, reliability is reduced because the grain boundary component (the oxides of the additional elements), which hinders the movement of oxygen vacancy, is readily reduced. Both temperature characteristics and reliability are reduced. In a situation where β/α is too high, compounds of the A-site elements and the additional elements are readily segregated, which reduces reliability. Note that Si is relatively readily contained in the grain boundary and enhances a sintering effect. Al is relatively readily contained in the grain boundary; and addition of Al together with Mn and Si at the same time further enhances the sintering effect. Thus, changing the ratio of Si to Al of the dielectric ceramic composition can change β/α.

The Ti content of the dielectric ceramic composition may exceed the total content of Si and Al of the dielectric ceramic composition; and the total content of Si and Al of the grain boundary 16 may exceed the Ti content of the grain boundary 16. Specifically, a value obtained by subtracting the total content of Si and Al of the dielectric ceramic composition with respect to 100 parts by mol B-site elements from the Ti content of the dielectric ceramic composition with respect to 100 parts by mol B-site elements may be 0.1 parts by mol or more. Moreover, a value obtained by subtracting the Ti content of the grain boundary 16 with respect to 100 parts by mol B-site elements from the total content of Si and Al of the grain boundary 16 with respect to 100 parts by mol B-site elements may be 0.1 parts by mol or more.

In a situation where the Ti content of the dielectric ceramic composition is not more than the total content of Si and Al thereof, compounds containing the A-site elements and Si and/or Al are readily segregated due to excessive Si and Al. This readily reduces reliability.

In a situation where the total content of Si and Al of the grain boundary 16 is not more than the Ti content thereof, reliability is readily reduced because of less grain boundary component (the oxides of the additional elements), which hinders the movement of oxygen vacancy.

Ti may constitute 2.0 parts by mol or more and 6.0 parts by mol or less out of 100 parts by mol B-site elements; the Ti content of the dielectric ceramic composition may exceed the total content of Mn and Cr of the dielectric ceramic composition; and the total content of Mn and Cr of the grain boundary 16 may exceed the Ti content of the grain boundary 16. Specifically, a value obtained by subtracting the total content of Mn and Cr of the dielectric ceramic composition with respect to 100 parts by mol B-site elements from the Ti content of the dielectric ceramic composition with respect to 100 parts by mol B-site elements may be 0.1 parts by mol or more. Moreover, a value obtained by subtracting the Ti content of the grain boundary 16 with respect to 100 parts by mol B-site elements from the total content of Mn and Cr of the grain boundary 16 with respect to 100 parts by mol B-site elements may be 0.1 parts by mol or more.

In a situation where the Ti content of the dielectric ceramic composition is not more than the total content of Mn and Cr thereof, compounds containing the A-site elements and the additional elements are readily segregated due to excessive Mn and/or Cr. This readily reduces reliability.

In a situation where the total content of Mn and Cr of the grain boundary 16 is not more than the Ti content thereof, reliability is readily reduced because of less grain boundary component (the oxides of the additional elements), which hinders the movement of oxygen vacancy.

The total content of the additional elements of the dielectric ceramic composition may be 1.8 parts by mol or more and 5.0 parts by mol or less with respect to 100 parts by mol B-site elements. Moreover, it may be that the total content of Mn and Cr of the dielectric ceramic composition exceeds the Si content of the dielectric ceramic composition and that the Si content of the grain boundary 16 exceeds the total content of Mn and Cr of the grain boundary 16. Specifically, a value obtained by subtracting the Si content of the dielectric ceramic composition with respect to 100 parts by mol B-site elements from the total content of Mn and Cr of the dielectric ceramic composition with respect to 100 parts by mol B-site elements may be 0.1 parts by mol or more. Moreover, a value obtained by subtracting the total content of Mn and Cr of the grain boundary 16 with respect to 100 parts by mol B-site elements from the Si content of the grain boundary 16 with respect to 100 parts by mol B-site elements may be 0.1 parts by mol or more.

In a situation where the total content of the additional elements is less than 1.8 parts by mol, the dielectric is less readily sintered. This readily reduces reliability. In a situation where the total content of the additional elements exceeds 5.0 parts by mol, compounds containing the A-site elements and the additional elements are readily segregated. This readily reduces reliability.

In a situation where the total content of Mn and Cr of the dielectric ceramic composition is not more than the Si content thereof, the dielectric is less readily sintered. This readily reduces reliability. In a situation where the Si content of the grain boundary 16 is not more than the total content of Mn and Cr thereof, reliability is readily reduced because of less grain boundary component (the oxides of the additional elements), which hinders the movement of oxygen vacancy.

The main phase grains 14 may have any average grain size. The average grain size may be, for example, 0.20 um or more and 1.50 um or less, or 0.50 um or more and 1.20 um or less. In particular, an average grain size of 0.50 um or more and 1.20 um or less readily improves reliability.

99 wt % or more of the above A-site elements, B-site elements, and additional elements of the dielectric ceramic composition is contained as simple oxides or complex oxides.

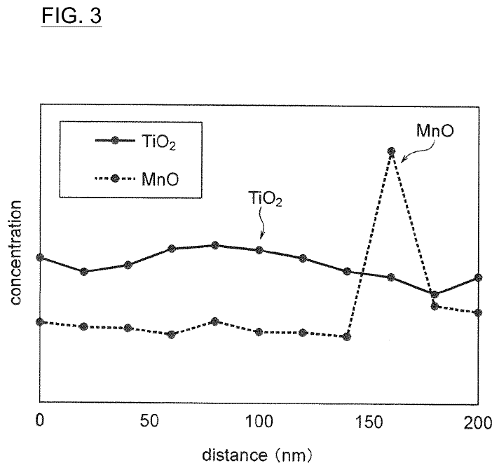

FIGS. 3 to 5 described later, which indicate simple oxides of the elements, show the content of such an element contained as a simple oxide, a complex oxide, or the like in terms of the simple oxide.

FIGS. 3 to 5 show results of a line analysis of each additional element content and the Ti content along a line 11 drawn in FIG. 2 from its left end to its right end. According to FIGS. 2 to 5, each element content does not greatly change inside the main phase grains 14. In contrast, at the grain boundary 16, while its Ti content does not greatly change, its additional elements content (β) greatly increases. Note that, because the dielectric ceramic composition shown in FIG. 2 does not contain Cr, the total content of Mn and Cr is equivalent to the Mn content.

FIG. 3 indicates that the Ti content of the main phase grains 14 exceeds their total content of Mn and Cr and that the total content of Mn and Cr of the grain boundary 16 exceeds its Ti content.

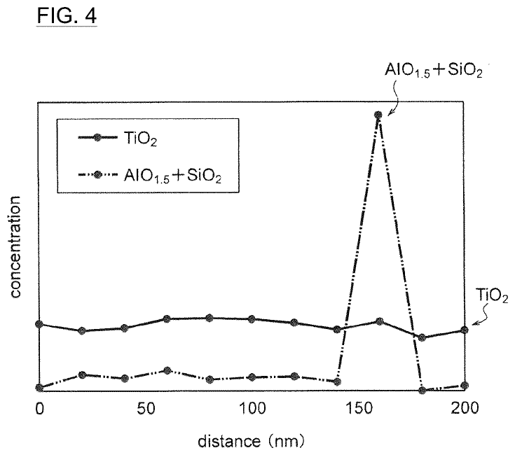

FIG. 4 indicates that the Ti content of the main phase grains 14 exceeds their total content of Si and Al and that the total content of Si and Al of the grain boundary 16 exceeds its Ti content.

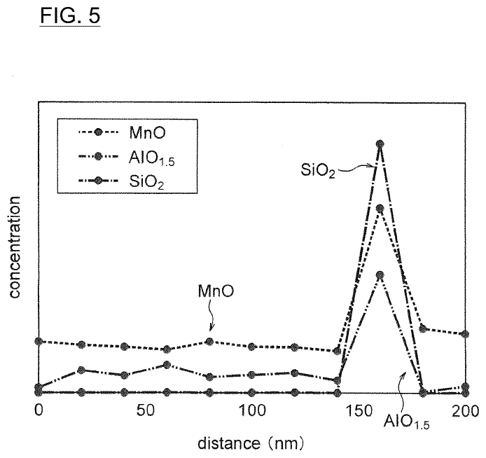

FIG. 5 shows a relationship between the Mn content, the Si content, and the Al content. While relatively much Mn is contained in the main phase grains 14, Si and Al are hardly contained in the main phase grains 14. Note that, even if Mn of the dielectric ceramic composition is replaced with Cr, there is a similar tendency.

Hereinafter, an example method of manufacturing the multilayer ceramic capacitor 1 shown in FIG. 1 is described.

First, steps of manufacturing the element body 10 are described. In the steps of manufacturing the element body 10, a dielectric paste to be the dielectric layers 2 after firing and an internal electrode paste to be the internal electrode layers 3 after firing are prepared.

Any method of manufacturing the dielectric paste may be used. The dielectric paste is manufactured using, for example, the following method. First, a raw material powder that mainly becomes the dielectric ceramic composition of the main phase grains 14 is prepared. As the raw material powder, a commercially available perovskite compound powder may be prepared. Alternatively, powders of oxides of the A-site elements of the perovskite compound and powders of oxides of the B-site elements thereof may be prepared, dispersed in a solvent (e.g., purified water), dried, and subject to a heat treatment to give the raw material powder. The heat treatment for providing the raw material powder may be carried out at any holding temperature. The holding temperature may be, for example, 900° C. or more and 1300° C. or less. The holding time is not limited. The holding time may be, for example, 0.5 hours or more and 5 hours or less.

Together with the powders of the oxides of the A-site elements and the powders of the oxides of the B-site elements of the perovskite compound, powders of oxides of the additional elements may be dispersed in the solvent at the same time.

Instead of the powders of the oxides of the above elements, powders of compounds that become the oxides of the elements by sintering (e.g., powders of carbonates of the elements) may be used. Alternatively, powders of complex compounds of the elements may be used.

The raw material powder may have any specific surface area at this time. The specific surface area measured using the BET adsorption method may be 3.0 m²/g or more and 20 m²/g or less. The larger the specific surface area of the raw material powder, the larger the average grain size of the main phase grains 14 of the dielectric ceramic composition eventually obtained tends to be.

Then, the raw material powder and the powders of the oxides of the additional elements (powders of compounds that become the oxides of the elements by sintering may be used) may be dispersed in a solvent (e.g., purified water), dried, and subject to a heat treatment to give a dielectric powder. The holding temperature of the heat treatment is not limited. The holding temperature may be, for example, 300° C. or more and 700° C. or less. The holding time is not limited. The holding time may be, for example, 0.5 hours or more and 5 hours or less. The higher the holding temperature and the longer the holding time of the heat treatment for preparing the dielectric powder, the lower β/α tends to be, because a less amount of the additional elements remains in the grain boundary of the dielectric ceramic composition eventually obtained.

The resultant dielectric powder, a binder, and a solvent (an organic solvent or water) are kneaded to give the dielectric paste. The binder and the solvent may be of any type. Instead of the binder and the solvent, an organic vehicle in which a binder and an organic solvent are mixed may be used. The dielectric paste may include additives, such as plasticizers and dispersants, as necessary.

The internal electrode paste is prepared by kneading a raw material of the above-mentioned conductive material, a binder, and a solvent (an organic solvent or water). The binder and the solvent may be of any type. The internal electrode paste may include additives, such as inhibitors and plasticizers, as necessary.

Using the resultant pastes, green sheets and internal electrode patterns are formed; and they are laminated to give a green chip.

The resultant green chip may be subject to a binder removal treatment as necessary. Conditions of the binder removal treatment are known conditions. The holding temperature may be, for example, 180° C. or more and 400° C. or less. The holding time may be, for example, 0.5 hours or more and 24 hours or less. The binder removal atmosphere is also not limited. In a reducing atmosphere, the holding temperature may be 1100° C. or less.

After the binder removal treatment, the green chip is fired to give the element body 10. In the present embodiment, the firing atmosphere may be a reducing atmosphere with an oxygen partial pressure of 2.0×10⁻¹³ atm or more and 1.0×10⁻⁷ atm or less. Other firing conditions are known conditions. The holding temperature may be, for example, 1200° C. or more and 1400° C. or less. The holding time may be, for example, 0.5 hours or more and 8.0 hours or less.

After firing, an annealing treatment may be carried out as necessary. Conditions of the annealing treatment are not limited. The holding temperature may be, for example, 500° C. or more and 1150° C. or less. The holding time may be, for example, 0.5 hours or more and 20 hours or less. The oxygen partial pressure of the annealing atmosphere is, for example, 1.0×10⁻⁹ atm or more and 3.0×10⁻⁵ atm or less.

The dielectric ceramic composition constituting the dielectric layers 2 of the resultant element body 10 given as above is the dielectric ceramic composition described above. End surfaces of this element body 10 are polished as necessary. To these end surfaces, an external electrode paste is applied. The applied paste is baked to form the external electrodes 4. On surfaces of the external electrodes 4, a coating layer is formed by plating or the like as necessary. Any method of preparing the external electrode paste may be used. The external electrode paste may be prepared using a method similar to the method of preparing the internal electrode paste.

In this manner, the multilayer ceramic capacitor 1 according to the present embodiment is manufactured.

Although one embodiment of the present invention has been described above, the present invention is not limited to the above embodiment and can be variously modified without departing from the gist of the present invention.

### EXAMPLES

Hereinafter, the present invention is described based on more detailed examples; however, the present invention is not limited to these examples.

### Experiment 1

In Experiment 1, multilayer ceramic capacitors 1 shown in FIG. 1 were manufactured using the following procedure.

First, a dielectric paste was prepared. A raw material powder (which may hereinafter be referred to as a “main-component raw material powder”) of a perovskite compound contained as a main component of main phase grains was produced. Specifically, a raw material powder of a Ca oxide, a raw material powder of a Sr oxide, a raw material powder of a Ba oxide, a raw material powder of a Zr oxide, and a raw material powder of a Ti oxide were prepared and weighed so as to provide the perovskite compound shown in Table 1. Note that “a raw material powder of a y oxide” denoted a powder of the y oxide and/or a powder of a compound that became the powder of the y oxide by a heat treatment. Then, the powders were dispersed in purified water, were dried, and were further subject to a heat treatment (holding temperature: 1150° C. to 1250° C., holding time: 0.5 to 5 hours) to give the main-component raw material powder having a specific surface area of about 3.5 to 20.0 m²/g measured using the BET adsorption method. Note that, in Example 6, the main-component raw material powder had a specific surface area of about 20 m²/g. In Example 7, the main-component raw material powder had a specific surface area of about 3.5 m²/g. In Examples and Comparative Examples of Experiment 1 other than Examples 6 and 7, the main-component raw material powder had a specific surface area of about 5.0 m²/g.

Separately, raw material powders of oxides of additional elements (a raw material powder of a Mn oxide, a raw material powder of a Cr oxide, a SiO₂ powder, and/or an Al₂O₃ powder) were prepared and weighed so that the oxides of the additional elements shown in Table 1 were contained in a dielectric ceramic composition. At this time, the raw material powders were weighed so that the additional elements were contained in descending order of content shown in Table 1 in terms of atomicity.

The main-component raw material powder and the powders of the oxides of the additional elements were dispersed in purified water, were dried, and were further subject to a heat treatment to give a dielectric powder. Except for Comparative Example 4, the holding temperature was 400° C. In Comparative Example 4, the holding temperature was 1200° C. The holding time was 2.0 hours.

The dielectric powder and an organic vehicle were kneaded to give the dielectric paste. With 100 parts by mass dielectric powder, 10 parts by mass polyvinyl butyral resin, 5 parts by mass dioctyl phthalate (DOP) as a plasticizer, and 100 parts by mass alcohol as a solvent were mixed using a ball mill; and the mixture was turned into a paste to give the dielectric paste.

A method of preparing an internal electrode paste was as follows. First, a Ni powder, terpineol, ethyl cellulose, and benzotriazole were prepared at a mass ratio of 44.6:52.0:3.0:0.4. They were kneaded using a triple-roll mill and were turned into a paste to give the internal electrode paste.

Then, using the dielectric paste and the internal electrode paste, green chips were manufactured with a sheet method. The green chips were then subject to a binder removal treatment, a firing treatment, and an annealing treatment to give element bodies 10 having a rectangular parallelepiped shape measuring 3.2 mm×1.6 mm×0.7 mm. 3.2 mm was the horizontal dimension in FIG. 1. 0.7 mm was the vertical dimension (in the lamination direction) in FIG. 1. The holding temperature of the firing treatment was 1200° C. to 1300° C. The holding time of the firing treatment was 2.0 hours. The firing atmosphere was a reducing atmosphere with an oxygen partial pressure of 2.0×10⁻¹³ atm or more and 1.0×10⁻⁷ atm or less. In each of the resultant element bodies 10, the number of dielectric layers 2 interposed between internal electrode layers 3 was ten; the dielectric layers 2 interposed between the internal electrode layers 3 had an average thickness of 5.0 um; and the internal electrode layers 3 had an average thickness of 1.2 um.

With regard to the holding temperature during firing, each sample was subject to preliminary testing at six holding temperatures, i.e., 1200° C., 1220° C., 1240° C., 1260° C., 1280° C., and 1300° C. The lowest holding temperature among the holding temperatures at which the element body 10 densified was adopted. Whether the element body 10 densified or not was checked by observing a section of the element body 10 using a SEM. Specifically, in the section of the element body 10, whether the area of pores in a field of view having an area of 450 um² or more was 2% or less of the area of the dielectric layers 2 in the field of view was checked. In a situation where the element body 10 did not densify at any of the holding temperatures, the holding temperature at which the degree of densification of the element body 10 was the highest was adopted. That is, the holding temperature was 1300° C.

Then, on outer surfaces of the above element bodies 10, a baked electrode layer containing Cu, a Ni plating layer, and a Sn plating layer were formed in the order mentioned to form external electrodes 4. Thus, the multilayer ceramic capacitors 1 were obtained.

### (Composition of Dielectric Ceramic Composition)

With regard to the composition of the dielectric ceramic composition, a composition analysis of the dielectric layers 2 was carried out using ICP optical emission spectroscopy. It was confirmed that the prepared composition and the composition of the dielectric ceramic composition had substantially the same A-site elements content, substantially the same B-site elements content, and substantially the same additional elements content. Tables 1 and 2 show the composition and the like of the dielectric, which were able to be checked in the composition analysis.

### (Composition of Grain Boundary 16)

The composition of a grain boundary 16, i.e., the additional elements content of the grain boundary 16, was measured in an element analysis using STEM-EDS. Specifically, five measurement locations were determined as in FIG. 2, and a line analysis was carried out there. The additional elements content at these locations included in the grain boundary 16 was averaged. Table 2 shows each additional element content with respect to 100 parts by mol B-site component. Moreover, Table 1 shows β, which denotes the total additional elements content.

### (Average Grain Size of Main Phase Grains 14)

The average grain size of the main phase grains 14 was measured by observing a section of the dielectric layers 2 using a SEM. Specifically, a field of view including at least fifty main phase grains 14 in their entirety was determined; equivalent circle diameters of these main phase grains 14 were calculated; and the measurement was averaged. Note that an equivalent circle diameter of a main phase grain 14 was a diameter of a circle having the same area as that of the main phase grain 14. Table 2 shows the results.

### (Temperature Characteristics)

The capacitance temperature coefficient τC (unit: ppm/° C.) was measured to evaluate temperature characteristics of the multilayer ceramic capacitors 1. Specifically, at 25° C. and at 125° C., a signal with a frequency of 1 kHz and an input signal level (measurement voltage) of 1 Vrms was input to the multilayer ceramic capacitors to measure the capacitance at each temperature. Using capacitance C25 at 25° C. and capacitance C125 at 125° C., τC was calculated with the following formula.

$$τ C = \{ ( C 125 - C 25 ) / C 25 \} \times \{ 1 / ( 125 - 25 ) \}$$

Ten multilayer ceramic capacitors 1 were subject to measurement of their τC, and their average was calculated. When the average τC was −30 ppm/° C. or more and +30 ppm/° C. or less, the temperature characteristics column of Table 2 was marked with “Passed”. When the average τC was less than −30 ppm/° C. or above +30 ppm/° C., the temperature characteristics column of Table 2 was marked with “Failed”.

### (Reliability Test)

High-temperature load life of the multilayer ceramic capacitors 1 was evaluated. Specifically, their lifetime was measured at 200° C. under application of a direct voltage of 800 V (160 V/um). In the present examples, the shorter one of the time during which insulation resistance was reduced by one digit from the start of the application or the time during which the samples broke down from the start of the application was defined as the lifetime. In the present examples, twenty multilayer ceramic capacitors 1 were subject to the above evaluation. From the lifetime of the multilayer ceramic capacitors 1, mean time to failure (MTTF) was calculated. When MTTF was 80.0 hours or more, reliability was deemed good. When MTTF was 100.0 hours or more, reliability was deemed particularly good. Table 2 shows the results.

TABLE 1

| | | | Dielectric | | Grain boundary | | | | |
|---|---|---|---|---|---|---|---|---|---|
| | | | Additional | | Additional | | | | |
| | | | element | | element | | | | |
| Sample | Perovskite compound | | [parts by mol] | | [parts by mol] | | | | |
| No. | A site | B site | Element | α | Mn | Cr | Si + Al | β | β/α |
| Example 1 | Ca_{0.70}Sr_{0.30} | Zr_{0.96}Ti_{0.04} | Mn, Si, Al | 4.0 | 6.6 | 0.0 | 11.9 | 18.5 | 4.6 |
| Example 2 | Ca_{0.70}Sr_{0.30} | Zr_{0.96}Ti_{0.04} | Cr, Si, Al | 4.0 | 0.0 | 5.1 | 8.5 | 13.6 | 3.4 |
| Example 3 | Ca_{0.60}Sr_{0.35}Ba_{0.05} | Zr_{0.96}Ti_{0.04} | Mn, Si, Al | 4.0 | 4.9 | 0.0 | 7.3 | 12.2 | 3.1 |
| Example 4 | Ca_{0.50}Sr_{0.45}Ba_{0.05} | Zr_{0.95}Ti_{0.05} | Mn, Si, Al | 5.0 | 6.9 | 0.0 | 12.0 | 18.9 | 3.8 |
| Comparative Example 1 | Sr | Zr_{0.96}Ti_{0.04} | Mn, Si, Al | 4.0 | 6.0 | 0.0 | 9.8 | 15.8 | 4.0 |
| Comparative Example 2 | Ba | Zr_{0.96}Ti_{0.04} | Mn, Si, Al | 4.0 | 3.5 | 0.0 | 6.2 | 9.7 | 2.4 |
| Comparative Example 3 | Ca_{0.70}Sr_{0.30} | Zr_{0.96}Ti_{0.04} | Si, Al | 4.0 | 0.0 | 0.0 | 25.3 | 25.3 | 6.3 |
| Example 5 | Ca_{0.70}Sr_{0.30} | Zr_{0.96}Ti_{0.04} | Cr, Si, Al | 2.0 | 0.0 | 3.9 | 4.0 | 7.9 | 4.0 |
| Comparative Example 4 | Ca_{0.70}Sr_{0.30} | Zr_{0.96}Ti_{0.04} | Mn, Si, Al | 4.0 | 3.1 | 0.0 | 7.7 | 10.8 | 2.7 |
| Example 6 | Ca_{0.70}Sr_{0.30} | Zr_{0.96}Ti_{0.04} | Mn, Si, Al | 2.0 | 4.1 | 0.0 | 3.6 | 7.7 | 3.9 |
| Example 7 | Ca_{0.70}Sr_{0.30} | Zr_{0.96}Ti_{0.04} | Mn, Si, Al | 4.0 | 7.1 | 0.0 | 16.1 | 23.2 | 5.8 |

TABLE 2

| | | | | | | | | | Main | | |
|---|---|---|---|---|---|---|---|---|---|---|---|
| | | | | | | | | | phase | | |
| | Dielectric | | | | Grain boundary | | | | grain | | |
| | [parts by mol] | | | | [parts by mol] | | | | Grain | Characteristics | |
| Sample | | | | Si < | | | | Si > | size | Temperature | Reliability |
| No. | Ti | Si + Al | Mn + Cr | Mn + Cr | Ti | Si + Al | Mn + Cr | Mn + Cr | [um] | characteristics | [h] |
| Example 1 | 4.0 | 2.0 | 2.0 | Yes | 3.8 | 11.9 | 6.6 | Yes | 0.70 | Passed | 148.4 |
| Example 2 | 4.0 | 2.0 | 2.0 | Yes | 4.1 | 8.5 | 5.1 | Yes | 0.65 | Passed | 111.5 |
| Example 3 | 4.0 | 2.0 | 2.0 | Yes | 3.8 | 7.3 | 4.9 | Yes | 0.95 | Passed | 123.8 |
| Example 4 | 5.0 | 2.2 | 2.8 | Yes | 4.8 | 12.0 | 6.9 | Yes | 0.80 | Passed | 104.9 |
| Comparative Example 1 | 4.0 | 2.0 | 2.0 | Yes | 3.7 | 9.8 | 6.0 | Yes | 1.00 | Failed | 65.2 |
| Comparative Example 2 | 4.0 | 2.0 | 2.0 | Yes | 4.1 | 6.2 | 3.5 | Yes | 0.95 | Failed | 0.1 |
| Comparative Example 3 | 4.0 | 4.0 | 0.0 | No | 3.8 | 25.3 | 0.0 | Yes | 1.35 | Passed | 3.5 |
| Example 5 | 4.0 | 0.6 | 1.4 | Yes | 4.0 | 4.0 | 3.9 | No | 0.65 | Passed | 98.4 |
| Comparative Example 4 | 4.0 | 2.0 | 2.0 | Yes | 3.8 | 7.7 | 3.1 | Yes | 1.15 | Failed | 65.1 |
| Example 6 | 4.0 | 0.6 | 1.4 | Yes | 4.4 | 3.6 | 4.1 | No | 1.40 | Passed | 95.5 |
| Example 7 | 4.0 | 2.0 | 2.0 | Yes | 3.7 | 16.1 | 7.1 | Yes | 0.80 | Passed | 132.7 |

According to Tables 1 and 2, in a situation where the perovskite compound having a predetermined composition was contained as the main component, predetermined amounts of predetermined additional elements were contained, and β/α was 3.0 or more and 6.0 or less, both temperature characteristics and reliability were good.

In contrast, in both Comparative Examples 1 and 2, in which Ca was not contained as an A-site element, both temperature characteristics and reliability were insufficient. In Comparative Example 2, in which both Ca and Sr were not contained as A-site elements, β/α was too low, and reliability was significantly low.

In Comparative Example 3, β/α was too high, and reliability was significantly low.

In Comparative Example 4, in which the holding temperature of the heat treatment prior to preparation of the dielectric paste was 1200° C., β/α was too low, and both temperature characteristics and reliability were insufficient.

### Experiment 2

In Experiment 2, except for Example 11, a method of manufacturing multilayer ceramic capacitors 1 was similar to the method of manufacturing those of Examples 1 to 5 of Experiment 1. However, the A-site elements content, the B-site elements content, and the additional elements content were changed within predetermined ranges.

Whereas the Al₂O₃ powder and the SiO₂ powder in their entirety were mixed with the raw material powders of the oxides of the additional elements in Example 1, a part of the Al₂O₃ powder and a part of the SiO₂ powder were mixed with the raw material powders such as the raw material powder of the Ca oxide in Example 11 for preparation of the main-component raw material powder. The remainder of the Al₂O₃ powder and the remainder of the SiO₂ powder were mixed with the raw material powders of the oxides of the additional elements. Other than that, Example 11 was carried out as in Example 1. Tables 3 and 4 show the results.

TABLE 3

| | | | Dielectric | | Grain boundary | | | | |
|---|---|---|---|---|---|---|---|---|---|
| | | | Additional | | Additional | | | | |
| | | | element | | element | | | | |
| Sample | Perovskite compound | | [parts by mol] | | [parts by mol] | | | | |
| No. | A site | B site | Element | α | Mr | Cr | Si + Al | β | β/α |
| Example 8 | Ca_{0.70}Sr_{0.30} | Zr_{0.982}Ti_{0.018} | Mn, Si, Al | 4.0 | 8.2 | 0.0 | 10.2 | 18.4 | 4.6 |
| Example 9 | Ca_{0.70}Sr_{0.30} | Zr_{0.980}Ti_{0.020} | Mn, Si, Al | 3.0 | 5.0 | 0.0 | 9.7 | 14.7 | 4.9 |
| Example 1 | Ca_{0.70}Sr_{0.30} | Zr_{0.96}Ti_{0.04} | Mn, Si, Al | 4.0 | 6.6 | 0.0 | 11.9 | 18.5 | 4.6 |
| Example 10 | Ca_{0.50}Sr_{0.40}Ba_{0.10} | Zr_{0.94}Ti_{0.06} | Mn, Si, Al | 4.0 | 7.2 | 0.0 | 12.0 | 19.2 | 4.8 |
| Comparative Example 6 | Ca_{0.50}Sr_{0.40}Ba_{0.10} | Zr_{0.93}Ti_{0.07} | Mn, Si, Al | 4.0 | 6.1 | 0.0 | 5.4 | 11.5 | 2.9 |
| Comparative Example 7 | Ca_{0.70}Sr_{0.30} | Zr_{0.96}Ti_{0.04} | Mn, Si, Al | 10.0 | 8.8 | 0.0 | 11.9 | 20.7 | 2.1 |
| Example 11 | Ca_{0.70}Sr_{0.30} | Zr_{0.95}Ti_{0.05} | Mn, Si, Al | 3.0 | 5.1 | 0.0 | 4.1 | 9.2 | 3.1 |

TABLE 4

| | | | | | | | | | Main | | |
|---|---|---|---|---|---|---|---|---|---|---|---|
| | | | | | | | | | phase | | |
| | Dielectric | | | | Grain boundary | | | | grain | | |
| | [parts by mol] | | | | [parts by mol] | | | | Grain | Characteristics | |
| Sample | | | | Si < | | | | Si > | size | Temperature | Reliability |
| No. | Ti | Si + Al | Mn + Cr | Mn + Cr | Ti | Si + Al | Mn + Cr | Mn + Cr | [um] | characteristics | [h] |
| Example 8 | 1.8 | 2.0 | 2.0 | Yes | 1.5 | 10.2 | 8.2 | No | 0.45 | Passed | 88.0 |
| Example 9 | 2.0 | 1.5 | 1.5 | Yes | 2.1 | 9.7 | 5.0 | Yes | 0.80 | Passed | 112.4 |
| Example 1 | 4.0 | 2.0 | 2.0 | Yes | 3.8 | 11.9 | 6.6 | Yes | 0.70 | Passed | 148.4 |
| Example 10 | 6.0 | 2.0 | 2.0 | Yes | 5.8 | 12.0 | 7.2 | Yes | 1.10 | Passed | 103.5 |
| Comparative Example 6 | 7.0 | 2.0 | 2.0 | Yes | 7.0 | 5.4 | 6.1 | No | 1.30 | Failed | 46.6 |
| Comparative Example 7 | 4.0 | 5.0 | 5.0 | Yes | 4.0 | 11.9 | 8.8 | Yes | 1.40 | Failed | 88.3 |
| Example 11 | 5.0 | 1.5 | 1.5 | Yes | 5.3 | 4.1 | 5.1 | No | 1.25 | Passed | 95.4 |

According to Tables 3 and 4, in a situation where β/α was 3.0 or more and 6.0 or less, both temperature characteristics and reliability were good. In a situation where the dielectric ceramic composition had a Ti content of 2.0 parts by mol or more and 6.0 parts by mol or less out of 100 parts by mol B-site elements and the grain boundary had a Ti content that was lower than the total content of Si and Al of the grain boundary, reliability was particularly good.

In contrast, in Comparative Examples 6 and 7, in which β/α was too low, temperature characteristics were insufficient. In Comparative Example 6, reliability was also insufficient.

### Experiment 3

Example 12 was carried out as in Example 1 except that the additional elements content was increased.

In Example 13, each B-site element content was changed within the predetermined range.

Moreover, whereas the raw material powder of the Mn oxide in its entirety was mixed with the raw material powders of the oxides of the additional elements in Example 1, a part of the raw material powder of the Mn oxide was mixed with the raw material powders such as the raw material powder of the Ca oxide in Example 13 for preparation of the main-component raw material powder. The remainder of the raw material powder of the Mn oxide was mixed with the raw material powders of the oxides of the additional elements. Other than that, Example 13 was carried out as in Example 1. Tables 5 and 6 show the results.

TABLE 5

| | | | Dielectric | | Grain boundary | | | | |
|---|---|---|---|---|---|---|---|---|---|
| | | | Additional | | Additional | | | | |
| | | | element | | element | | | | |
| Sample | Perovskite compound | | [parts by mol] | | [parts by mol] | | | | |
| No. | A site | B site | Element | α | Mn | Cr | Si + Al | β | β/α |
| Example 12 | Ca_{0.70}Sr_{0.30} | Zr_{0.96}Ti_{0.04} | Mn, Si, Al | 8.5 | 12.9 | 0.0 | 14.3 | 27.2 | 3.2 |
| Example 1 | Ca_{0.70}Sr_{0.30} | Zr_{0.96}Ti_{0.04} | Mn, Si, Al | 4.0 | 6.6 | 0.0 | 11.9 | 18.5 | 4.6 |
| Example 13 | Ca_{0.70}Sr_{0.30} | Zr_{0.98}Ti_{0.02} | Mn, Si, Al | 4.0 | 1.5 | 0.0 | 10.7 | 12.2 | 3.1 |
| Example 14 | Ca_{0.70}Sr_{0.30} | Zr_{0.96}Ti_{0.04} | Mn, Si, Al | 1.5 | 2.0 | 0.0 | 4.0 | 6.0 | 4.0 |
| Example 15 | Ca_{0.70}Sr_{0.30} | Zr_{0.96}Ti_{0.04} | Mn, Si, Al | 1.8 | 4.3 | 0.0 | 5.6 | 9.9 | 5.5 |
| Example 1 | Ca_{0.70}Sr_{0.30} | Zr_{0.96}Ti_{0.04} | Mn, Si, Al | 4.0 | 6.6 | 0.0 | 11.9 | 18.5 | 4.6 |
| Example 16 | Ca_{0.70}Sr_{0.30} | Zr_{0.96}Ti_{0.04} | Mn, Si, Al | 4.8 | 7.4 | 0.0 | 12.5 | 19.9 | 4.1 |
| Example 12 | Ca_{0.70}Sr_{0.30} | Zr_{0.96}Ti_{0.04} | Mn, Si, Al | 8.5 | 12.9 | 0.0 | 14.8 | 27.7 | 3.3 |
| Comparative Example 8 | Ca_{0.70}Sr_{0.30} | Zr_{0.96}Ti_{0.04} | Si, Mn, Al | 4.0 | 5.7 | 0.0 | 21.8 | 27.5 | 6.9 |
| Example 7 | Ca_{0.70}Sr_{0.30} | Zr_{0.96}Ti_{0.04} | Mn, Si, Al | 4.0 | 7.1 | 0.0 | 16.1 | 23.2 | 5.8 |
| Example 17 | Ca_{0.70}Sr_{0.30} | Zr_{0.98}Ti_{0.02} | Al, Mn, Si | 5.0 | 7.7 | 0.0 | 8.5 | 16.2 | 3.2 |

TABLE 6

| | | | | | | | | | Main | | |
|---|---|---|---|---|---|---|---|---|---|---|---|
| | | | | | | | | | phase | | |
| | Dielectric | | | | Grain boundary | | | | grain | | |
| | [parts by mol] | | | | [parts by mol] | | | | Grain | Characteristics | |
| Sample | | | | Si < | | | | Si > | size | Temperature | Reliability |
| No. | Ti | Si + Al | Mn + Cr | Mn + Cr | Ti | Si + Al | Mn + Cr | Mn + Cr | [um] | characteristics | [h] |
| Example 12 | 4.0 | 4.3 | 4.2 | Yes | 4.1 | 14.3 | 12.9 | No | 1.45 | Passed | 90.7 |
| Example 1 | 4.0 | 2.0 | 2.0 | Yes | 3.8 | 11.9 | 6.6 | Yes | 0.70 | Passed | 148.4 |
| Example 13 | 2.0 | 2.2 | 1.8 | Yes | 2.2 | 10.7 | 1.5 | No | 1.25 | Passed | 82.1 |
| Example 14 | 4.0 | 0.8 | 0.8 | Yes | 4.3 | 4.0 | 2.0 | No | 1.30 | Passed | 80.2 |
| Example 15 | 4.0 | 0.9 | 0.9 | Yes | 3.9 | 5.6 | 4.3 | Yes | 0.65 | Passed | 100.4 |
| Example 1 | 4.0 | 2.0 | 2.0 | Yes | 3.8 | 11.9 | 6.6 | Yes | 0.70 | Passed | 148.4 |
| Example 16 | 4.0 | 2.4 | 2.4 | Yes | 4.3 | 12.5 | 7.4 | Yes | 0.75 | Passed | 110.6 |
| Example 12 | 4.0 | 4.2 | 4.3 | Yes | 4.1 | 14.8 | 12.9 | Yes | 0.75 | Passed | 90.7 |
| Comparative Example 8 | 4.0 | 2.5 | 1.5 | No | 4.1 | 21.8 | 5.7 | Yes | 1.10 | Passed | 39.8 |
| Example 7 | 4.0 | 2.0 | 2.0 | Yes | 4.0 | 16.1 | 7.1 | Yes | 0.80 | Passed | 132.7 |
| Example 17 | 2.0 | 2.8 | 2.2 | Yes | 2.1 | 8.5 | 7.7 | No | 0.45 | Passed | 92.1 |

According to Tables 5 and 6, in Examples 12 and 13, in which the perovskite compound having the predetermined composition was contained as the main component, the predetermined amounts of the predetermined additional elements were contained, and β/α was 3.0 or more and 6.0 or less, both temperature characteristics and reliability were good.

In Example 12, in which the Ti content of the dielectric ceramic composition was lower than the total content of Mn and Cr thereof, reliability was lower than that of Example 1. In Example 13, in which the Ti content of the grain boundary was higher than the total content of Mn and Cr thereof, reliability was lower than that of Example 1.

### Experiment 4

Examples 12 and 14 to 16 were carried out as in Example 1 except that the additional elements content was changed. Tables 5 and 6 show the results.

According to Tables 5 and 6, in Examples 12 and 14 to 16, in which the perovskite compound having the predetermined composition was contained as the main component, the predetermined amounts of the predetermined additional elements were contained, and β/α was 3.0 or more and 6.0 or less, both temperature characteristics and reliability were good.

In Examples 1, 15, and 16, in which the total content of the additional elements of the dielectric ceramic composition was 1.8 parts by mol or more and 5.0 parts by mol or less with respect to 100 parts by mol B-site elements, reliability was particularly good. In contrast, in Example 14, in which the total content of the additional elements was 1.5 parts by mol, sintering did not sufficiently proceed compared to Examples 1, 15, and 16, and reliability was lower than that of Examples 1, 15, and 16. In Example 12, in which the total content of the additional elements of the dielectric ceramic composition was 8.5 parts by mol with respect to 100 parts by mol B-site elements, reliability was lower than that of Examples 1, 15, and 16. It was assumed that this was because compounds containing the additional elements and the A-site elements were generated relatively a lot.

### Experiment 5

Example 17 and Comparative Example 8 were carried out as in Example 7 except that the additional elements content was changed and that the B-site elements content was changed within the predetermined range. Tables 5 and 6 show the results.

According to Tables 5 and 6, in Example 17, in which the perovskite compound having the predetermined composition was contained as the main component, the predetermined amounts of the predetermined additional elements were contained, and β/α was 3.0 or more and 6.0 or less, both temperature characteristics and reliability were good.

However, in Example 17, because the total content of Mn and Cr of the dielectric ceramic composition fell below the Al content thereof, sintering did not proceed compared to Example 7. Moreover, in Example 17, because the Si content of the grain boundary fell below the total content of Mn and Cr thereof, there was less component hindering the movement of oxygen vacancy in the grain boundary. Consequently, in Example 17, reliability was lower than that of Example 7.

In Comparative Example 8, in which β/α exceeded 6.0, reliability was significantly lower than that of Example 7.

### Experiment 6

In Examples 18 and 19 and Comparative Example 9, the holding temperature of Example 7 during firing was changed to change the average grain size of the main phase grains 14. Specifically, the holding temperature of Example 7 during firing was reduced by 40° C. in Comparative Example 9, was reduced by 20° C. in Example 18, and was increased by 20° C. in Example 19. Tables 7 and 8 show the results. Tables 7 and 8 also show the test results of Example 6, in which the specific surface area of the main-component raw material powder was changed to change the average grain size of the main phase grains 14.

TABLE 7

| | | | Dielectric | | Grain boundary | | | | |
|---|---|---|---|---|---|---|---|---|---|
| | | | Additional | | Additional | | | | |
| | | | element | | element | | | | |
| Sample | Perovskite compound | | [parts by mol] | | [parts by mol] | | | | |
| No. | A site | B site | Element | α | Mn | Cr | Si + Al | β | β/α |
| Comparative Example 9 | Ca_{0.70}Sr_{0.30} | Zr_{0.96}Ti_{0.04} | Mn, Si, Al | 4.0 | 4.0 | 0.0 | 4.7 | 8.7 | 2.2 |
| Example 18 | Ca_{0.70}Sr_{0.30} | Zr_{0.96}Ti_{0.04} | Mn, Si, Al | 4.0 | 5.4 | 0.0 | 8.1 | 13.5 | 3.4 |
| Example 7 | Ca_{0.70}Sr_{0.30} | Zr_{0.96}Ti_{0.04} | Mn, Si, Al | 4.0 | 7.1 | 0.0 | 16.1 | 23.2 | 5.8 |
| Example 19 | Ca_{0.70}Sr_{0.30} | Zr_{0.96}Ti_{0.04} | Mn, Si, Al | 4.0 | 5.6 | 0.0 | 13.9 | 19.5 | 4.9 |
| Example 6 | Ca_{0.70}Sr_{0.30} | Zr_{0.96}Ti_{0.04} | Mn, Si, Al | 2.0 | 4.0 | 0.0 | 3.7 | 7.7 | 3.9 |

TABLE 8

| | | | | | | | | | Main | | |
|---|---|---|---|---|---|---|---|---|---|---|---|
| | | | | | | | | | phase | | |
| | Dielectric | | | | Grain boundary | | | | grain | | |
| | [parts by mol] | | | | [parts by mol] | | | | Grain | Characteristics | |
| Sample | | | | Si < | | | | Si > | size | Temperature | Reliability |
| No. | Ti | Si + Al | Mn + Cr | Mn + Cr | Ti | Si + Al | Mn + Cr | Mn + Cr | [um] | characteristics | [h] |
| Comparative Example 9 | 4.0 | 2.0 | 2.0 | Yes | 3.9 | 4.7 | 4.0 | No | 0.40 | Passed | 59.9 |
| Example 18 | 4.0 | 2.0 | 2.0 | Yes | 4.2 | 8.1 | 5.4 | Yes | 0.50 | Passed | 117.0 |
| Example 7 | 4.0 | 2.0 | 2.0 | Yes | 4.1 | 16.1 | 7.1 | Yes | 0.80 | Passed | 132.7 |
| Example 19 | 4.0 | 2.0 | 2.0 | Yes | 4.0 | 13.9 | 5.6 | Yes | 1.20 | Passed | 108.6 |
| Example 6 | 4.0 | 0.6 | 1.4 | Yes | 4.1 | 3.7 | 4.0 | No | 1.40 | Passed | 95.5 |

According to Tables 7 and 8, in each Example in which the perovskite compound having the predetermined composition was contained as the main component, the predetermined amounts of the predetermined additional elements were contained, and β/α was 3.0 or more and 6.0 or less, both temperature characteristics and reliability were good. In each Example in which the average grain size of the main phase grains 14 was 0.50 um or more and 1.20 um or less, reliability was particularly improved.

In contrast, in Comparative Example 9, in which β/α was too low, reliability was low. It was assumed that a reason why β/α of Comparative Example 9 was too low was that too low a holding temperature during firing caused insufficient sintering.

While β/α was 3.0 or more and 6.0 or less in Example 6, with the additional elements being solid-dissolved in the main phase grains 14, the main phase grains 14 had an average grain size of above 1.20 um. It was thus assumed that the balance between the A-site elements and the B-site elements was lost, resulting in reduction of reliability compared to Examples 7, 18, and 19.

### REFERENCE NUMERALS

1 . . . multilayer ceramic capacitor
2 . . . dielectric layer
3 . . . internal electrode layer
4 . . . external electrode
10 . . . element body
14 . . . main phase grain
16 . . . grain boundary

What is claimed is:

1. A dielectric ceramic composition comprising:
main phase grains; and
a grain boundary between the main phase grains,
wherein
the main phase grains comprise a perovskite compound as a main component;
the perovskite compound comprises at least Ca and Sr as A-site elements and at least Zr and Ti as B-site elements;
the dielectric ceramic composition further comprises an oxide of at least one additional element; and
β/α is 3.0 or more and 6.0 or less, where
α (unit: parts by mol) denotes a content of the at least one additional element of the dielectric ceramic composition with respect to 100 parts by mol B-site elements, and
β (unit: parts by mol) denotes a content of the at least one additional element of the grain boundary with respect to 100 parts by mol B-site elements.

2. The dielectric ceramic composition according to claim 1, wherein
Ti constitutes 2.0 parts by mol or more and 6.0 parts by mol or less out of 100 parts by mol B-site elements;
the at least one additional element comprises at least Si and Al;
the dielectric ceramic composition has a Ti content exceeding a total content of Si and Al of the dielectric ceramic composition; and
the grain boundary has a total content of Si and Al exceeding a Ti content of the grain boundary.

3. The dielectric ceramic composition according to claim 1, wherein
Ti constitutes 2.0 parts by mol or more and 6.0 parts by mol or less out of 100 parts by mol B-site elements;
the at least one additional element comprises at least one selected from the group consisting of Mn and Cr;
the dielectric ceramic composition has a Ti content exceeding a total content of Mn and Cr of the dielectric ceramic composition; and
the grain boundary has a total content of Mn and Cr exceeding a Ti content of the grain boundary.

4. The dielectric ceramic composition according to claim 1, wherein
the at least one additional element comprises Si, Al, and at least one selected from the group consisting of Mn and Cr;
the dielectric ceramic composition has a total content of the at least one additional element of 1.8 parts by mol or more and 5.0 parts by mol or less with respect to 100 parts by mol B-site elements;
the dielectric ceramic composition has a total content of Mn and Cr exceeding a Si content of the dielectric ceramic composition; and
the grain boundary has a Si content exceeding a total content of Mn and Cr of the grain boundary.

5. The dielectric ceramic composition according to claim 1, wherein the main phase grains have an average grain size of 0.50 um or more and 1.20 um or less.

6. A multilayer ceramic electronic device comprising the dielectric ceramic composition according to claim 1.
